(19) United States
(12) Patent Application Publication
(10) Pub. No.: US 2010/0051406 A1
(43) Pub. Date: Mar. 4, 2010

(54) DOUBLE-ACTING DRIVE FOR ADJUSTMENT DEVICES IN MOTOR VEHICLES

(76) Inventor: Georg Scheck, Weitramsdorf (DE)

Correspondence Address: CHRISTIE, PARKER & HALE, LLP, PO BOX 7068, PASADENA, CA, 91109-7068, US

(21) Appl. No.: 12/312,727

(22) PCT Filed: Nov. 21, 2007
(86) PCT No.: PCT/EP2007/062637

§ 371 Date: Jun. 17, 2009

(30) Foreign Application Priority Data
Nov. 27, 2006 (DE) 10 2006 056 531.2

(51) Int. Cl. F16D 13/14

(52) U.S. Cl. 192/75

(57) ABSTRACT

A double-acting drive for adjustment devices in motor vehicles comprises: a drive element which is turnable or rotatable in the one or the other direction about a drive axis; an output wheel which is connected to the adjustment device, is adjustable in its angle and comprises a rotationally symmetric inner wall; and a band-shaped coupling element, which is arranged in the force flow between the drive element and the output wheel, is braced with the rotationally symmetric inner wall of the output wheel and carries along the output wheel in circumferential direction if the drive element is moved from a starting position in the one or the other direction. The ends of the band-shaped coupling element overlap each other and form coupling levers which run secant-shaped on both sides of the drive axis and which are carried along by the drive element in dependence on the rotational direction of the drive element for expanding and bracing the band-shaped coupling element with the rotationally symmetric inner wall of the output wheel and which abut on support noses of the band-shaped coupling element, the support noses being arranged substantially perpendicular to the coupling levers.

### CROSS-REFERENCE TO RELATED APPLICATIONS

This application is a National Phase patent application of International Patent Application Number PCT/EP2007/062637, filed on Nov. 21, 2007, which claims priority of German Patent Application No. 10 2006 056 531.2, filed Nov. 27, 2006, which is incorporated herein by reference.

### BACKGROUND

The invention relates to a double-acting drive for adjustment devices in motor vehicles according to the preamble of claim 1.

From DE 103 61 148 A1 an adjustment device for generating a two-sided rotational movement is known, comprising a drive element rotatable about a drive axis, an output wheel being adjustable in its angle by actuating the drive element with a hollow cylindrical abutment area and a coupling being located within the force flow between the drive element and the output wheel, which transfers an adjustment movement of the drive element to the output wheel only if the drive element is moved from a neutral starting position into the one or the other direction. The coupling contains a coil-spring band abutting the abutment area of the output wheel with pretension, the coil-spring band comprising a circumference of less than 360° and abutment areas for transferring force from the drive element to the output wheel, an amplification lever operationally connected to the drive element and the spring ends of the coil-spring band and two transfer levers rotatably connected to the drive axis and each having a first lever arm, which in each case opposes a support arm being arranged with an angle with respect to the coil-spring band, and having a second lever arm, which abuts a stop fixed on a housing and bolts connecting the amplification lever with the drive element. Between the transfer levers return springs are arranged, which, for returning the coil-spring band, in dependence on the direction of the returning push in each case a first lever arm of the transfer lever against one of the support arms of the coil-spring band, wherein, for the returning of the drive element, in each case a second lever arm in dependence on the direction of the return movement pushes against the connecting bolt connected to the drive element.

### SUMMARY

It is an objective of the instant invention to provide a double-acting drive for adjustment devices in motor vehicles which is constructed in a simple way and with a reduced space requirement from few functional parts, can be fabricated in a cheap way, is functionally secure and has a long live.

According to an aspect of the invention, a double-acting drive for adjustment devices in motor vehicles, comprises:
a drive element which is turnable or rotatable in the one or the other direction about a drive axis;
an output wheel which is connected to the adjustment device, is adjustable in its angle and comprises a rotationally symmetric inner wall; and
a band-shaped coupling element, which is arranged in the force flow between the drive element and the output wheel, is braced with the rotationally symmetric inner wall of the output wheel and carries along the output wheel in circumferential direction if the drive element is moved from a starting position in the one or the other direction,
wherein ends of the band-shaped coupling element overlap each other and form coupling levers which run secant-shaped on both sides of the drive axis and which are carried along by the drive element in dependence on the rotational direction of the drive element for expanding and bracing the band-shaped coupling element with the rotationally symmetric inner wall of the output wheel and which abut on support noses of the band-shaped coupling element, the support noses being arranged substantially perpendicular to the coupling levers.

By using a band-shaped coupling element with coupling lever, abutment band and support noses formed as one part, whose ends overlap each other and form coupling levers extending to both sides of the drive axis in the shape of secants for transferring force from the drive element to the output wheel, which abut during the force transfer on the support noses of the band-shaped coupling element, a double-acting drive having a small space requirement is provided that is constructed in a very simple way and consists of few functional parts, can be fabricated in a cheap way and can be assembled, because of the few functional parts, with little effort.

At the same time the construction of the coupling lever and the support noses as one-piece integral part of the band-shaped coupling element ensures a secure force transfer from the drive element to the output wheel by a corresponding expansion of the band-shaped coupling element and by carrying along the drive wheel in the circumferential direction if the drive element is moved from a neutral starting position in the one or the other direction. Herein, the coupling levers function both as switching levers for introducing a force or torque transfer from the drive element to the output wheel and as amplification levers, which transfer the adjustment force introduced from the drive element in an amplified manner from the drive element to the support noses and in this way via the abutment band of the band-shaped coupling element to the output wheel securely also in unfavourable conditions and at large drive forces.

In addition the solution according to the invention ensures, through the optimum force transfer with a broad-area abutment of the band-shaped coupling element to the rotationally symmetric inner wall of the output wheel and through the use of a flexible and accordingly long-live band-shaped coupling element as coupling between the drive element and the output wheel, a long live of the double-acting drive also at large loads.

For optimizing the transfer of a drive torque from the drive element to the output wheel, the band-shaped coupling element abuts on the rotationally symmetric inner wall of the output wheel about a circumference of nearly 360° and, because of a larger diameter with respect to the rotationally symmetric inner wall of the output wheel, with pretension on the rotationally symmetric inner wall of the output wheel, such that a maximum abutment area of the band-shaped coupling element, with its width given by the constructional depth of the double-acting drive, with sufficient contact force is ensured.

For the optimum support of the coupling levers when rotating or turning the drive element from its starting position in the one or the other direction and, hereby, for the optimum tensioning of the band-shaped coupling element with the rotationally symmetric inner wall of the output wheel during the force transfer from the drive element to the output wheel, the coupling levers are, in the starting position of the drive, aligned substantially parallel to each other running immediately next to the drive axis and the support noses are aligned approximately radially into the inner space of the output wheel and towards the center of the outer flanks of the coupling levers pointing away from each other, and the support noses oppose, in the starting position of the drive, with a small play the outer flanks of the coupling levers pointing away from each other, wherein the connecting line of the support noses directed radially into the inner space of the output wheel is displaced with respect to the drive axis.

The band-shaped coupling element with integrally formed coupling levers and support noses ensures that the abutment band of the band-shaped coupling element is braced all the stronger with the rotationally symmetric inner wall of the output wheel, the stronger the drive element presses against the coupling levers, such that a slipping-through of the band-shaped coupling element is with increasing drive force efficiently prevented. Therein, the band-shaped coupling element abuts with its internal stress on the rotationally symmetric inner wall of the output wheel, is expanded when a drive force or a drive torque, respectively, is introduced, supports itself on the support noses and braces with the rotationally symmetric inner wall of the output wheel for the slip-free force or torque transfer from the drive element to the output wheel.

As band-shaped coupling element, a metallic coil-spring band as well as a plastic band, in particular, can be used, wherein by accordingly choosing the material both of the spring band and of the rotationally symmetric inner wall of the output wheel an optimum force transfer when carrying along the output wheel and a small friction when returning the band-shaped coupling element to the zero point or starting position is ensured.

For the secure transfer of the support and drive forces from the drive element to the output wheel, the support noses and coupling levers comprise a larger cross-sectional area than the abutment band of the band-shaped coupling element abutting on the rotationally symmetric inner wall of the output wheel.

The solution according to the invention can be realized in different ways by different embodiments.

A first embodiment is characterized by two band-shaped coupling elements being arranged inversely to each other, whose coupling levers comprise a longitudinal recess receiving the drive axis and whose ends opposing the coupling levers form the support noses.

In this embodiment, for each rotational direction of the double-acting drive, a band-shaped coupling element with integrally formed coupling lever, abutment band and support noses is provided, into which in each case a coupling lever functioning as switch and amplification lever and a support nose for supporting the respective coupling lever when introducing a drive force for expanding the band-shaped coupling element is integrated. Therein, the longitudinal recess provides that the band-shaped coupling element acting in the respective rotating or turning direction of the drive element supports itself, for expanding and achieving a force-fit abutment of the abutment band on the rotationally symmetric inner wall of the output wheel, on the support nose and not on the drive axis.

In this embodiment, the support noses of the band-shaped coupling element are bent with an angle around in each case a locationally invariant stop, conventionally being formed as part of the drive housing, from the band-shaped coupling element radially into the inner space of the output wheel.

The support noses are guided in a bent manner from the abutment band of the band-shaped coupling element around the locationally invariant stops, wherein the locationally invariant stops serve to fasten the support nose of the band-shaped coupling element that is unloaded in the respective rotating or turning direction of the drive element, such that the in the respective rotating or a turning direction unloaded band-shaped coupling element, due to its coupling lever being carried along, contracts and exerts no or only a minimal friction force onto the output wheel counteracting the rotational movement of the output wheel.

For stabilizing the abutment of the abutment bands of the two band-shaped coupling elements arranged inversely with respect to each other on the rotationally symmetric inner wall of the output wheel, a third, locationally invariant stop is provided that is located with a small distance from the band-shaped coupling elements on that side which, with respect to the drive axis, opposes the overlapping of the band-shaped coupling elements.

In this embodiment of the solution according to the invention, the drive element is arranged radially between the drive axis and the ends of the coupling levers opposing the overlapping of the band-shaped coupling elements.

If, when introducing a drive torque, the drive element acts in the one or the other direction onto the one or the other coupling lever, this leads to an amplification, dependent on the lever arm of the distance of the drive element from the support noses, of the force, with which the respective coupling lever braces the associated support nose and thereby the abutment band of the band-shaped coupling element with the rotationally symmetric surface of the output wheel and ensures a secure connection between the drive element and the rotationally symmetric surface of the output wheel.

The reason for this lies in the self amplifying effect of this arrangement, because, with increasing force acting from the drive element onto the coupling lever, also such forces increase which are transferred to the support nose and act towards bracing the abutment band of the band-shaped coupling element with the rotationally symmetric surface of the drive element.

For the mutual bracing of the band-shaped coupling elements, for the pretensioned abutment of the abutment bands of the band-shaped coupling elements on the rotationally symmetric inner wall of the output wheel, for the play-free abutment of the coupling levers on the drive element and on the support noses and for the returning of the coupling levers and of the drive element after an adjustment movement back into the starting position, a spring element being displaced from the drive axis is arranged between the coupling levers.

The spring element can, in a first variant, be formed as a compression spring and can be arranged between the coupling levers on the side opposing, with respect to the drive axis, the drive element, wherein the ends of the longitudinal recess of the coupling levers in the starting position of the drive element are aligned substantially symmetrically to the drive axis.

In this variant a large fundamental contact force is ensured with which the band-shaped coupling elements ensure, also at a minimum friction value between the abutment bands of the band-shaped coupling elements and the rotationally symmetric inner wall of the output wheel when introducing a drive force or, respectively, a drive torque, a slip-free transfer of the drive force or, respectively, the drive torque to the output wheel. Disadvantageous within this variant is a somewhat larger sliding or rubbing torque when returning the band-shaped coupling elements from the turned position into the starting position.

A second variant of the spring element consists of a tension spring connected to the ends of the coupling lever, wherein the longitudinal recesses of the coupling levers are, in the starting position of the drive element, arranged eccentrically to the drive axis, i.e. they are displaced with respect to their ends from the drive axis in directions opposing each other.

Within this variant the abutment band of the associated band-shaped coupling element is also immediately carried along in the respective rotation direction through the turning of the coupling lever acting in the respective turning or rotating direction of the drive element, whereas the in each case other coupling lever is pulled along by the spring force and the associated band-shaped coupling element is moved along by a small distance until, subsequent to a small play, the longitudinal recess in the inactive coupling lever abuts on the drive axis and, due to the abutment of the support nose of the inactive band-shaped coupling element on the locationally invariant stop, the respective band-shaped coupling element contracts and thereby at the same time tensions the tension spring.

A second embodiment of the solution according to the invention is characterized by a single band-shaped coupling element abutting, with pretension, on the rotationally symmetric inner wall of the output wheel, the coupling element comprising coupling levers formed on both sides of an abutment band and support noses formed from the abutment band running between the coupling levers.

In this embodiment, the drive torque is transferred from the drive element to the output wheel by a one-piece band-shaped coupling element, wherein also in this embodiment the coupling levers serving as switch and amplification levers are formed as one piece or integrally on the ends of the band-shaped coupling element and comprise, because of the bending load acting onto the coupling levers when introducing a drive torque, a larger cross-sectional area than the abutment band of the band-shaped coupling element.

In this embodiment of a one-piece and double-acting band drive as well, a spring element bracing the coupling levers against each other and returning the coupling levers, after a displacement of the output wheel, back into the starting position is provided for the mutual bracing of the band-shaped coupling elements, for the pretensioned abutment of the abutment bands of the band-shaped coupling elements on the rotationally symmetric inner wall of the output wheel. Different to the previous embodiments, a small motion play is provided in the starting position of the one-piece and double-acting band drive between the coupling lever and the drive element and, respectively, between the coupling lever and the support noses.

In a first variant, the spring element consists of a compression spring, which is connected, on the ends of the coupling levers, with lever arms crossing each other.

For returning the double-acting drive into the starting position after turning the drive element and, therewith, after introducing a rotational movement into the output wheel, the compression spring supports itself both on the lever arms of the coupling levers crossing each other and on the stops of a housing, such that the compression spring is compressed and tensioned together with the turning of the coupling lever acting in the respective rotating direction and, after termination of the drive-sided rotational torque, the relaxing compression spring returns the respective coupling lever and, thereby, the drive into the starting position.

Within this variant of the arrangement of the spring element, the drive element either can be arranged radially between the coupling levers and between the drive axis and the lever arms on the ends of the coupling levers crossing each other or can consist of two drive claws which, being displaced sideways, oppose the ends of the coupling levers on their outer sides being directed away from each other.

Alternatively, the spring element can consist of a tension spring bracing the ends of the coupling levers with each other, wherein the drive element is arranged radially between the drive axis and the tension spring and no overlapping of lever arms on the ends of the coupling levers is accordingly necessary.

To ensure, also in this embodiment, an automatic returning of the double-acting drive after transferring a rotational movement to the output wheel, the bent ends of the tension spring abut both on fittings on the ends of the coupling levers and on abutments of a housing.

### BRIEF DESCRIPTION OF THE DRAWINGS

The embodiments being derivable from the solution according to the invention and relying on the same fundamental principle as well as the idea underlying the invention shall be explained further making use of the embodiments shown in the drawings. Herein,

FIG. 1 shows a schematic cross section through a double-acting drive comprising two band-shaped coupling elements with, on its ends, integrated coupling levers and support noses and a tension spring for pretensioning the band-shaped coupling elements;

FIG. 2 shows a schematic cross section through a double-acting drive as in FIG. 1 with a compression spring for pretensioning the band-shaped coupling elements;

FIG. 3 shows a schematic cross section through a double-acting drive comprising a one-piece band-shaped coupling element with integrated coupling levers and support noses as well as a tension spring for pretensioning the band-shaped coupling element and returning the drive;

FIG. 4 shows a schematic cross section through a double-acting drive comprising a one-piece band-shaped coupling element according to FIG. 3 with a compression spring for pretensioning the band-shaped coupling element and returning the drive and a drive element being arranged between the coupling levers and

FIG. 5 shows a schematic cross section through a double-acting drive as in FIG. 4 comprising drive claws being arranged on both sides of the coupling levers.

### DESCRIPTION OF EMBODIMENTS

In the following, several embodiments are described with reference to the Figures.

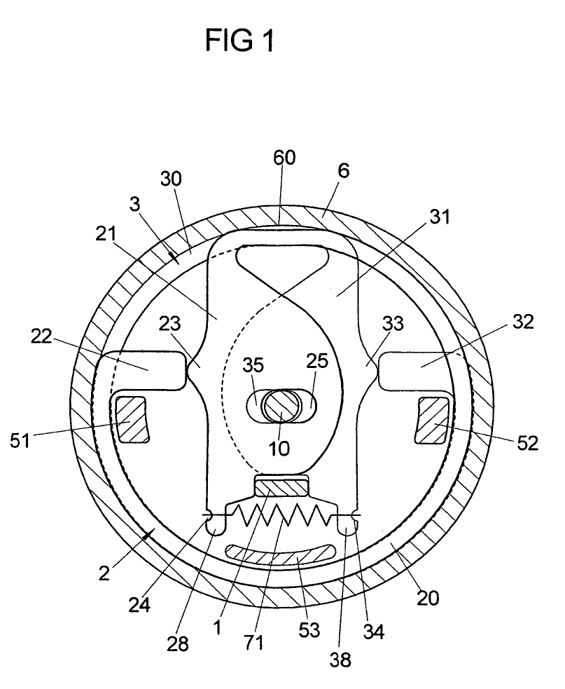

FIG. 1 shows a schematic cross section through a double-acting drive with a drive element 1, which for example is connected with a drive lever being turnable about a drive axis 10, the drive lever being turnable starting from a starting position in the one or the other direction about the drive axis 10. An output wheel 6 with a rotationally symmetric, in this embodiment cylindrical inner wall 60 is connected with an adjustment device of a motor vehicle, for example with a seat, backrest or lordosis adjustment of a motor vehicle seat, and is turned in dependence on the turning direction of the drive lever starting from its starting position in the one or the other rotation direction and adjusts the adjustment device connected to the output wheel 6 in the one or the other adjustment direction. For example, turning the drive lever in the clockwise direction about the drive axis 10 leads to a rotation of the output wheel 6 in the clockwise direction and, accordingly, to a lifting of a lordosis support or, respectively, when turning the drive lever in the counter-clockwise direction about the drive axis 10, this leads to a rotation of the output wheel 6 in the counter-clockwise direction and, accordingly, to a lowering of the lordosis support.

For the force or torque transfer from the drive element 1 to the output wheel 6, two band-shaped coupling elements 2, 3, preferably made from plastics, are provided which are arranged inversely with respect to each other and comprise a larger diameter than the inner wall 60 of the drive wheel, such that they are inserted under pretension into the output wheel 6. The two coupling elements 2, 3 are each active only in one rotational direction of the drive lever and, thereby, for one rotation of the drive element 1 about the drive axis 10, i.e. the coupling elements 2, 3 can turn the output wheel 6 each only in one rotational direction.

The coupling elements 2, 3 are assembled in one piece from each an abutment band 20, 30 abutting on the rotationally symmetric inner wall 60 of the output wheel 6, a coupling lever 21, 31 being formed on the one end of the abutment band 20, 30 with an, with respect to the abutment bands 20, 30, enlarged cross section and a support nose 22, 32 being formed on the other end of the abutment band 20, 30 and being directed radially inwards, i.e. toward the drive axis 10, with as well an, with respect to the abutment band 20, 30, enlarged cross section. Because of the inverse arrangement of the coupling elements 2, 3, the ends of the abutment bands 20, 30 overlap at the transition into the coupling levers 21, 31, which extend secant-shaped and, in the starting position of the double-acting drive, substantially parallel to each other to the drive axis 10, receive the drive axis 10 in longitudinal recesses 25, 35 and are eccentrically arranged with respect to each other such that the one ends of the longitudinal recesses 25, 35 are located with small distance from the drive axis 10, whereas the in each case other ends of the longitudinal recesses 25, 35 are spaced apart from the drive axis 10 in directions opposing each other such that in the starting position of the double-acting drive, without influence of external forces, the drive axis 10 is located in the vicinity of the in the top view left end of the longitudinal recess 25 of the first coupling element 2 and the in the top view right end of the longitudinal recess 35 of the second coupling element 3.

The support noses 22, 32 are arranged on the same height above the drive axis 10 radially inwards and are arranged in the starting position of the double-acting drive perpendicular to the outer flanks of the coupling levers 21, 31 being directed away from each other and are displaced with a small play from protrusions 23, 33 of the coupling levers 21, 31. The support noses 22, 32 are guided around two locationally invariant stops 51, 52, which are preferably stops fixed on a housing, and are arranged with an angle to the central part 20, 30 of the plastic bands 2, 3. A third locationally invariant stop 53 serves for stabilizing the position of the abutment bands 20, 30 of the coupling elements 2, 3 and is located about centrally between the two locationally invariant stops 51, 52 located in the vicinity of the support noses 22, 32.

The lever ends 28, 38 of the coupling levers 21, 31 opposing the overlapping of the coupling elements 2, 3 comprise fittings 24, 34 for receiving the ends of a tension spring 71 such that the drive element 1 is arranged between the tension spring 71 and the drive axis 10. The tension spring 71 braces the two coupling levers 21, 31 against the drive element 1 and against each other such that the two coupling levers 21, 31 abut in the starting position, without influence of external forces, on the drive element 1 and the abutment bands 20, 30 of the coupling elements 2, 3 abut with pretension on the cylinder-shaped inner wall 60 of the output wheel 6.

Subsequently, the functionality of the double-acting drive shown in FIG. 1 when transferring a drive torque from the drive element 1 to the output wheel 6 shall be explained further.

In the starting position or neutral position shown in FIG. 1 with no influence of external forces onto the double-acting drive, the tension spring 71 pulls via the fittings 24, 34 the lever ends 28, 38 of the coupling levers 21, 31 together until the inner sides of the coupling levers 21, 31 abut on the drive element 1. Because the drive element 1 is arranged between the lever ends 28, 38 connected to the tension spring 71 and the protrusions 23, 33 of the coupling levers 21, 31, a torque is applied to the coupling levers 21, 31, which pushes the protrusions 23, 33 in a play-free manner against the support noses 22, 32 of the band-shaped coupling elements 2, 3. The abutment bands 20, 30 of the band-shaped coupling elements 2, 3 abut, because of their larger diameter with respect to the diameter of the inner wall 60 of the output wheel 6, with pretension, i.e. also play-free, on the inner wall 60 of the output wheel 6.

When turning the drive lever and, thereby, the drive element 1 in the clockwise direction about the drive axis 10, the drive element 1 pushes against the first, in the top view left coupling lever 21 and, thereby, pushes its protrusion 23 even stronger against the support nose 22, until a counter torque on the output side acting on the output wheel 6 is overcome and, because of the bracing of the abutment band 20 of the band-shaped coupling element 2 with the inner wall 60 of the output wheel 6, the output wheel 6 is rotated along in the clockwise direction.

Due to the tension spring 71 bracing the lever ends 28, 38 with each other, also the second, in the top view right coupling lever 31 is moved along in the clockwise direction about the drive axis 10. After a short rotation angle the second, in the top view right support nose 32 strikes the locationally fixed stop 52 such that the band-shaped coupling element 3 is prevented from rotating further in the clockwise direction. Due to the support force at the locationally fixed stop 52 acting on the support nose 32, the abutment band 30 of the band-shaped coupling element 3 contracts, until it abuts on the locationally fixed stops 51, 52 being radially displaced from the inner side of the abutment bands 20, 30 and the second coupling element 3 is contracted. Accordingly, the second coupling element 3 exerts no or an only minimal braking force on the output wheel 6 being rotated in the clockwise direction about the drive axis 10.

If the drive element 1 is rotated further in the clockwise direction about the drive axis 10, the lever end 28 of the first coupling lever 21 is separated further from the starting position, such that, because of the lever ends 28, 38 of the coupling lever 21, 31 moving away from each other, the tension spring 71 is pulled apart and, thereby, is tensioned during the adjustment movement of the first coupling element 2.

If the turning movement of the drive lever is terminated such that no drive torque is exerted from the drive element 1 to the first coupling lever 21, the tensioned tension spring 71 pulls, with its end fitted into the fitting 24 of the lever end 28 of the first coupling lever 21, the first coupling lever 21 from the stop on the first support nose 22 to the right, until the longitudinal recess 25 of the first coupling lever 21 supports itself on the drive axis 10. Thereby, the bracing between the first coupling element 2 with the cylindrical inner wall 60 of the output wheel 6 is cancelled and, at the same time, due to the tension force of the tension spring 71 and the support of the first coupling lever 21 on the first support nose 22, the end of the first coupling lever 21 in the vicinity of the overlapping of the coupling elements 2, 3 is moved in the top view towards the left such that the first coupling element 2 is contracted and can be moved back with low friction on the cylinder-shaped inner wall 60 of the output wheel 6 into the starting position. The returning into the starting position therein is caused by the relaxing tension spring 71.

If the drive lever is rotated against the clockwise direction about the drive axis 10 and the drive element 1 is accordingly rotated against the clockwise direction about the drive axis 10, the second coupling element 3 is loaded, and analogously to the previously described functionality the output wheel 6 is rotated against the clockwise direction until the turn movement of the drive lever about the drive axis 10 is terminated and the double-acting drive is moved back into its starting position.

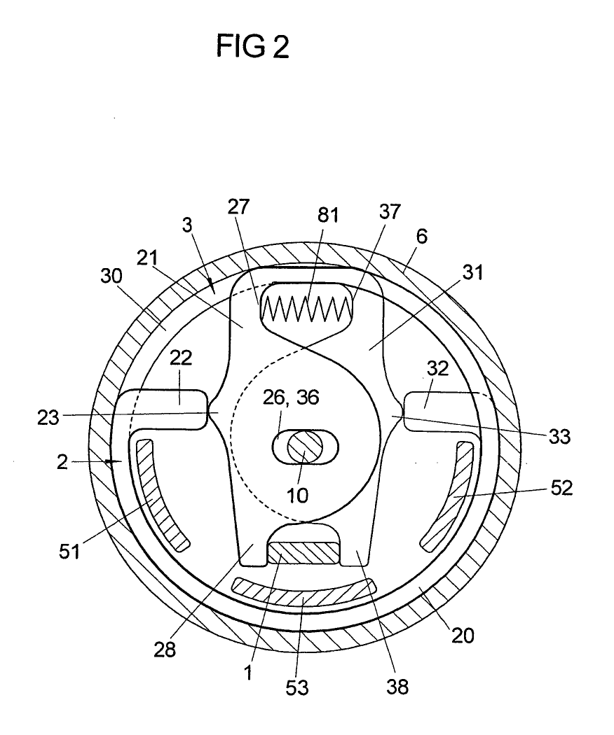

The double-acting drive shown in FIG. 2 in a schematic cross section differs from the drive according to FIG. 1 in that, rather than a tension spring 71 tensioning the lever ends 28, 38 of the coupling levers 21, 31 with each other, a compression spring 81 is provided, which is arranged and is effective, with respect to the drive axis 10, on the opposing side between the abutment areas 27, 37 of the coupling levers 21, 31 neighbouring the overlapping of the coupling elements 2, 3. In this embodiment the two coupling levers 21, 31 both comprise longitudinal recesses 26, 36 which are in the starting position of the double-acting drive arranged substantially congruent with each other such that about equal small distances from the drive axis 10 to the two ends of the longitudinal recesses 26, 36 result.

In the starting position shown in FIG. 2 or in the neutral position with no influence of external forces onto the double-acting drive, the compression spring 81 pushes both the lever ends 28, 38 of the coupling levers 21, 31 against the drive element 1 and the protrusions 23, 33 of the coupling levers 21, 31 in a play-free manner against the support noses 22, 32 of the band-shaped coupling elements 2, 3. The abutment bands 20, 30 of the band-shaped coupling elements 2, 3 abut, because of their larger diameter with respect to the diameter of the inner wall 60 of the output wheel 6, with pretension, i.e. also play-free, on the inner wall 60 of the output wheel 6.

When turning the drive lever and thereby the drive element 1 in the clockwise direction about the drive axis 10, the drive element 1 pushes against the first, in the top view left coupling lever 21 and thereby pushes its protrusion 23 even stronger against the support nose 22, until a counter moment on the output side acting onto the output wheel 6 is overcome and the output wheel 6 is, due to the bracing of the abutment band 20 of the band-shaped coupling element 2 with the inner wall 60 of the output wheel 6, rotated along in the clockwise direction.

Due to the compression spring 81 arranged between the coupling levers 21, 31, also the second, in the top view right coupling lever 31 is moved along in the clockwise direction about the drive axis 10. After a short rotational angle the second, in the top view right support nose 32 strikes the locationally fixed stop 52 such that the band-shaped coupling element 3 is prevented from a further rotation in the clockwise direction. Due to the support force acting onto the support nose 32 at the locationally fixed stop 52, the abutment band 30 of the band-shaped coupling element 3 is contracted, until it abuts on the locationally fixed stops 51, 52 being radially displaced from the inner side of the abutment bands 20, 30 and the second coupling element 3 is contracted. Accordingly, the second coupling element 3 applies no or only a minimum braking force to the output wheel 6 which is rotated in the clockwise direction about the drive axis 10.

When rotating the drive element 1 further in the clockwise direction about the drive axis 10, the lever end 28 of the first coupling lever 21 is separated further from the starting position and from the lever end 38 of the second coupling lever 31, which, together with the band-shaped coupling element 3, is prevented from a further rotation in the clockwise direction because of the abutment of the second support nose 32 on the locationally fixed stop 52, whereas the abutment areas 27, 37 of the coupling levers 21, 31 are moved towards each other, compress the compression spring 81 and thereby tension it during the adjustment movement of the first coupling element 2.

If the rotational movement of the drive lever is terminated such that no drive moment is applied from the drive element 1 onto the first coupling lever 21, the tensioned compression spring 81 pushes the first coupling lever 21 back. Thereby, the bracing between the first coupling element 2 and the cylindrical inner wall 60 of the output wheel 6 is cancelled and at the same time, due to the compression force of the compression spring 81 and the support of the first coupling lever 21 on the first support nose 22, the abutment areas 27 of the first coupling lever 21 are moved in the top view towards the left, such that the first coupling element 2 is contracted and moves back, with a with respect to the embodiment according to FIG. 1 somewhat larger slide or friction moment on the cylinder-shaped inner wall 60 of the output wheel 6, into the starting position. The returning into the starting position herein is affected by the relaxing compression spring 81.

If the drive lever is turned against the clockwise direction about the drive axis 10 and accordingly the drive element 1 is rotated against the clockwise direction about the drive axis 10, the second coupling element 3 is loaded and analogously to the previously described functionality the output wheel 6 is rotated against the clockwise direction until the turn movement of the drive lever about the drive axis 10 is terminated and the double-acting drive is moved back into its starting position.

Within the arrangement according to FIG. 2, hence, a large fundamental drive force is achieved and a larger slide torque when returning the drive into the starting position is accepted.

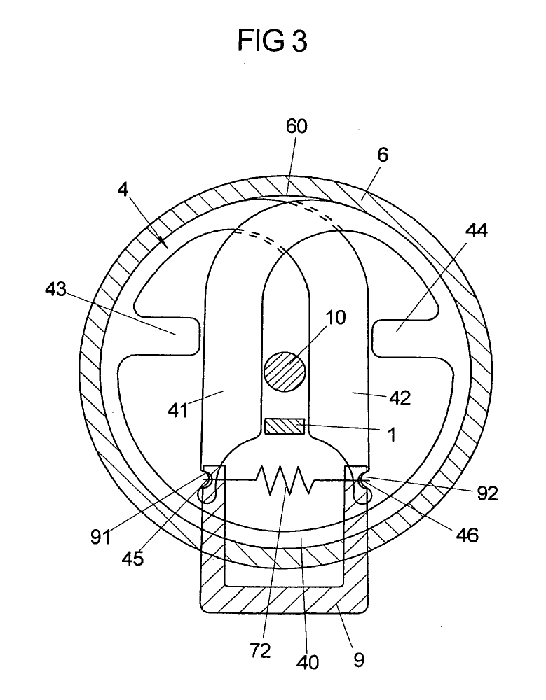

The embodiments of the invention shown in FIGS. 3 to 5 use, in contrast to the embodiments according to FIGS. 1 and 2, a single, one-piece band-shaped coupling element 4 for the torque transfer from a drive element 1 to an output wheel 6.

The double-acting drive shown cross-sectionally in FIG. 3 comprises a drive element 1 which is for example connected to a not further shown drive lever which can be turned about the drive axis 10 starting from a zero-point or starting position in the one or the other direction. Via the one-piece band-shaped coupling element 4 the output wheel 6, which is arranged concentrically to the drive axis 10 and has a cylinder-shaped inner wall 60, is carried along in the one or the other rotational direction and causes an adjustment of the adjustment device connected to the output wheel 6 in the one or the other rotational direction. The one-piece band-shaped coupling element 4 is configured as a coil-spring band or, preferably, as plastic band and comprises an abutment band 40 abutting under pretension on the cylinder-shaped inner wall 60 of the output wheel 6 about a region of little less than 360°, the ends of the abutment band 40 overlapping each other and transitioning into coupling levers 41, 42 having an enlarged cross section with respect to the abutment band 40. The coupling levers 41, 42 are secant-shaped and are guided in the starting position of the double-acting drive parallel to each other immediately past the drive axis 10. Between the coupling levers 41, 42 the drive axis 10 and the drive element 1 are situated, the drive element 1 having the same width as the diameter of the drive axis 10. Somewhat above the horizontal central axis of the double-acting drive two support noses 43, 44 are, directed radially inwards, shaped out of the abutment band 40 of the coupling element 4 and comprise an also enlarged cross section with respect to the abutment band 40. The support noses 43, 44 directed radially inwards are arranged approximately perpendicularly to the side flanks of the coupling levers 41, 42 and confront the side flanks of the coupling levers 41, 42 with a small distance.

At the ends of the coupling levers 41, 42 facing the overlapping of the coupling element 4 the ends of a tension spring 72 are connected to fittings 45, 46 of the coupling levers 41, 42 and at the same time are supported on recesses 91, 92 of a housing 9.

The function of the double-acting drive shown in FIG. 3 matches substantially the function of the drive shown in FIGS. 1 and 2 with two band-shaped coupling elements being inverse with respect to each other and being inserted with pretension into the cylinder-shaped output wheel 6.

If a drive moment acts onto the drive element 1 for example in the clockwise direction by correspondingly turning a drive lever connected to the drive element 1 in the clockwise direction about the drive axis 10, the drive element 1 pushes against the first, in the top view left coupling lever 41 and pushes it against the first, in the top view left support nose 43. The amplified drive force acting onto the support nose 43 leads to a bracing of the abutment band 40 of the coupling element 4 with the cylinder-shaped inner wall 60 of the output wheel 6, such that the output wheel 6 rotates along together with the drive element 1 in the clockwise direction. Therein, the fitting 45 at the end of the first coupling lever 41 lifts the tension spring 72 from the retainer 91 fixed on the housing such that the tension spring 72 is tensioned. Due to the abutment band 40 bracing with the cylinder-shaped inner wall 60 of the output wheel 6, also the second, in the top view right coupling lever 42 is rotated in an unloaded manner along in the clockwise direction, whereas the right end of the tension spring 72 remains hanging at the retainer 92 fixed on the housing. Thereby, the tension spring 72 is tensioned further until the end of the rotation of the drive element 1.

With terminating the turning movement of the drive lever and thereby the drive moment acting onto the drive element 1, the drive element 1 is guided back into the starting position, wherein the tension spring 72 causes, via its connection with the fitting 45, a permanent abutment of the first coupling lever 41 on the drive axis 10. Because of the lateral flexibility of the coupling levers 41, 42 the first coupling lever 41 can support itself on the drive axis 10 during the movement of the drive element 1, such that the drive element 1 lifts off from the first coupling lever 41. Therein, the tension spring 72 acts only on the first coupling lever 41 being supported centrally on the drive axis 10, a tension force acting onto the end of the first coupling lever 41 opposing the tension spring 72 in the region of the overlapping of the coupling element 4, the tension force being directed against the tension force of the tension spring 72 and acting in the sense of a contraction of the abutment band 40, such that the coupling element 4 is moved back with minimum friction on the cylinder-shaped inner wall 60 of the output wheel 6 into the starting position. Thereby, it is prevented that during the returning of the drive element 1 into the starting position the second, in the top view right coupling lever 42 strikes the support nose 44, which would lead to a bracing of the coupling element 4 with the output wheel 6 and would accordingly move it back again from the displaced position into the starting position.

During a turn movement of the drive lever against the clockwise direction about the drive axis 10, the second, in the top view right coupling lever 42 is in an analogous manner pushed against the support nose 44 facing with a small play its side flank, such that the coupling element 4 braces with the cylinder-shaped inner wall 60 of the output wheel 6 and the output wheel 6 is rotated against the clockwise direction.

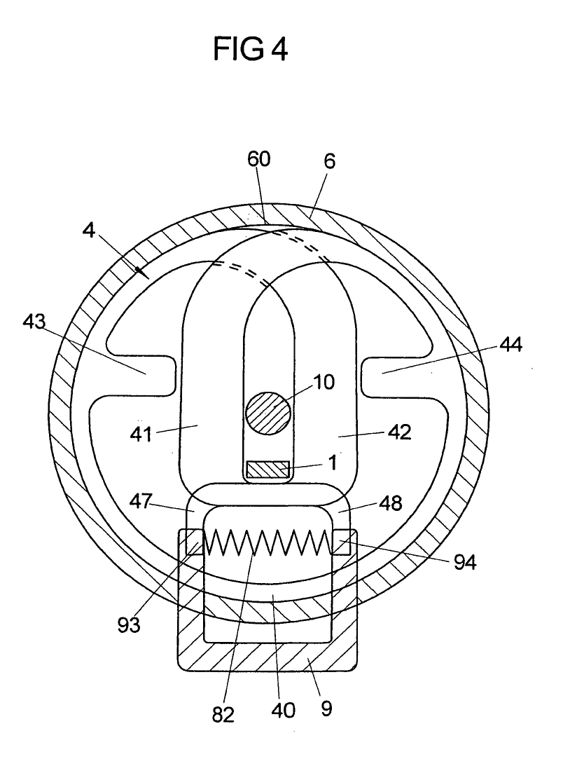

The cross section through a double-acting drive shown schematically in FIG. 4 differs from the embodiment according to FIG. 3 in that, instead of a tension spring 72, a compression spring 82 is provided and, for achieving the same effect, the ends or the lever arms 47, 48 of the coupling levers 41, 42, respectively, are crossed once more. In this embodiment, the compression spring 82 abuts on the crossing lever arms 47, 48 as well as on stops 93, 94 fixed on the housing.

The function of the double-acting drive shown schematically in FIG. 4 matches the previously described function of the drive according to FIG. 3.

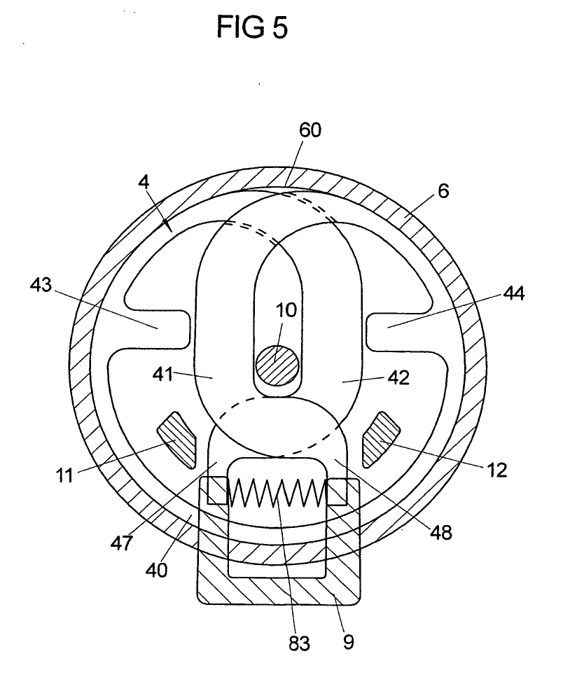

While in the embodiment according to FIG. 4 the drive element 1 is arranged radially displaced with respect to the drive axis 10 between the two coupling levers 41, 42, in the embodiment according to FIG. 5, instead of a single drive element 1, two drive claws 11, 12 are provided which oppose the outer sides of the crossing lever arms 47, 48 of the coupling levers 41, 42 at otherwise matching construction of the double-acting drive corresponding to the embodiment according to FIG. 4 and allow for an improved space usage, because in this region of the double-acting drive more space is available than between the coupling levers 41, 42.

1-28. (canceled)

29. Double-acting drive for adjustment devices in motor vehicles, comprising:
a drive element which is turnable or rotatable in the one or the other direction about a drive axis;
an output wheel which is connected to the adjustment device, is adjustable in its angle and comprises a rotationally symmetric inner wall; and
a band-shaped coupling element, which is arranged in the force flow between the drive element and the output wheel, is braced with the rotationally symmetric inner wall of the output wheel and carries along the output wheel in circumferential direction if the drive element is moved from a starting position in the one or the other direction;
wherein ends of the band-shaped coupling element overlap each other and form coupling levers which run secant-shaped on both sides of the drive axis and which are carried along by the drive element in dependence on the rotational direction of the drive element for expanding and bracing the band-shaped coupling element with the rotationally symmetric inner wall of the output wheel and which abut on support noses of the band-shaped coupling element, the support noses being arranged substantially perpendicular to the coupling levers.

30. Drive according to claim 29, wherein the band-shaped coupling element abuts on the rotationally symmetric inner wall of the output wheel with pretension.

31. Drive according to claim 29, wherein the band-shaped coupling element abuts on the rotationally symmetric inner wall of the output wheel about a circumference of approximately 360°.

32. Drive according to claim 29, wherein the coupling levers in the starting position of the drive are arranged running substantially parallel to each other immediately next to the drive axis.

33. Drive according to claim 29, wherein the support noses, in the starting position of the drive, face with a small play the outer flanks of the coupling levers directed away from each other.

34. Drive according to claim 29, wherein the support noses are directed radially into the inner space of the output wheel.

35. Drive according to claim 34, wherein the connecting line of the support noses directed radially into the inner space of the output wheel is displaced with respect to the drive axis.

36. Drive according to claim 29, wherein the support noses of the band-shaped coupling element are directed towards the center of the outer flanks of the coupling levers being directed away from each other.

37. Drive according to claim 29, wherein the support noses and coupling levers comprise a larger cross-sectional area than the abutment band of the band-shaped coupling element abutting on the rotationally symmetric inner wall of the output wheel.

38. Drive according to claim 29, wherein the band-shaped coupling element consists of plastics.

39. Drive according to claim 29, wherein the band-shaped coupling element consists of a metal, preferably a spring steel.

40. Drive according to claim 29, further comprising two band-shaped coupling elements being arranged inversely to each other, whose coupling levers comprise a longitudinal recess receiving the drive axis and whose ends facing away from the coupling levers form the support noses.

41. Drive according to claim 40, wherein the support noses of the band-shaped coupling elements are bent about in each case one locationally invariant stop directed from the band-shaped coupling element radially into the inner space of the output wheel.

42. Drive according to claim 41, wherein a third locationally invariant stop which is arranged having a small distance from the band-shaped coupling elements on the side facing the overlapping of the band-shaped coupling elements with respect to the drive axis.

43. Drive according to claim 29, wherein the drive element is arranged radially between the drive axis and the lever ends of the coupling levers.

44. Drive according to claim 29, further comprising a spring element bracing the band-shaped coupling elements against each other and, after a displacement of the output wheel, restoring into the starting position.

45. Drive according to claim 44, wherein the spring element is arranged distanced from the drive axis between the coupling levers.

46. Drive according to claim 44, wherein a compression spring arranged between the abutment areas of the coupling levers on the side opposing the drive element with respect to the drive axis.

47. Drive according to claim 46, wherein the ends of the longitudinal recesses of the coupling levers in the starting position of the drive element are arranged substantially symmetric to the drive axis.

48. Drive according to claim 44, further comprising a tension spring connected to the ends of the coupling levers.

49. Drive according to claim 48, wherein the ends of the longitudinal recesses of the coupling levers are arranged in the starting position of the drive element eccentrically to the drive axis.

50. Drive according to claim 29, further comprising a single band-shaped coupling element abutting with pretension on the rotationally symmetric inner wall of the drive wheel, the coupling element comprising coupling levers formed on both ends of the abutment band and support noses formed in one piece from the abutment band which extends between the coupling levers.

51. Drive according to claim 50, further comprising a spring element bracing the coupling elements against each other and, after a displacement of the output wheel, restoring into the starting position.

52. Drive according to claim 51, wherein the drive element is arranged radially between the drive axis and the spring element which braces the two ends of the coupling levers with each other and against the drive element.

53. Drive according to claim 52, wherein the spring element consists of a tension spring whose bent ends abut both on fittings on the ends of the coupling levers and on stops of a housing.

54. Drive according to claim 52, wherein the lever arms formed on the end of the coupling levers cross each other and are connected with a compression spring.

55. Drive according to claim 52, wherein the compression spring is supported both on the lever arms of the coupling levers crossing each other and on the stops of a housing.

56. Drive according to claim 53, wherein the drive element consists of two drive claws which, displaced laterally, oppose the ends of the coupling levers on their outer flanks directed away from each other.
